(19) United States
(12) Patent Application Publication
(10) Pub. No.: US 2011/0014879 A1
(43) Pub. Date: Jan. 20, 2011

(54) CUSTOMIZED ANTENNA ARRANGEMENT

(75) Inventors: Bill Alberth, Prairie Grove, IL (US); Eric Krenz, Crystal Lake, IL (US)

Correspondence Address: MOTOROLA MOBILITY, INC, 600 NORTH US HIGHWAY 45, W2-55BB, LIBERTYVILLE, IL, 60048-5343, US

(73) Assignee: MOTOROLA, INC., SCHAUMBURG, IL (US)

(21) Appl. No.: 12/505,048

(22) Filed: Jul. 17, 2009

(51) Int. Cl. H04B 1/40; H01Q 1/24

(52) U.S. Cl. 455/75; 343/702

(57) ABSTRACT

A communication device (10 or 50 or 200) having a customized antenna arrangement (14 or 54) for the communication device formed on a first housing portion (201 or 203) having etched thereon customized metallization providing optimized performance for frequencies most often used by a user and a second housing portion (201 or 203) for mating with the housing portion where the first housing portion and the second housing portion contain or enclose at least a substantial portion of a transceiver (12) coupled to a controller (30). Other embodiments are disclosed.

### CROSS REFERENCE TO RELATED APPLICATIONS

U.S. patent application Ser. No. ______, Attorney Docket No. CS36402BLACK356 entitled “Split Band Diversity Antenna Arrangement”, and U.S. patent application Ser. No. ______, Attorney Docket No. CS35902KRENZ359 entitled “Antenna Arrangement for Multimode Communication Device”, both concurrently filed on Jul. 17, 2009 by the same Assignee herein.

### FIELD OF THE DISCLOSURE

This invention relates generally to antennas, and more particularly to a multi-band antenna operating on several distinct bands.

### BACKGROUND

As wireless devices become exceedingly slimmer and greater demands are made for antennas operating on a diverse number of frequency bands, the design of common antennas such as a Planar Inverted “F” Antenna (PIFA) in such slim devices has become particularly challenging due to size and performance requirements. Antenna configurations typically used for certain bands can easily interfere or couple with antenna configurations used for other bands. Thus, designing antennas for operation across a number of diverse bands such that each band has a sufficient bandwidth of operation becomes a feat in artistry as well as utility, particularly when such arrangements must meet the volume requirements of today's smaller communication devices.

Another concern with antenna designs in general for multi-band phones includes optimizing antenna performance across desired frequency bands. Existing designs may have call drop issues or poor performance that relate to loading on antennas caused by hand grips on a portion of the phone or other loading conditions. Furthermore, antennas designed for PCS bands are generally configured to be optimized across the entire PCS band, which may not be ideal for a number of scenarios.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate the embodiments and explain various principles and advantages, in accordance with the present disclosure.

FIG. 1 depicts an embodiment of a communication device and antenna arrangement in accordance with the present disclosure;

FIG. 2 depicts an alternative embodiment of the communication device and antenna arrangement of FIG. 1 in accordance with the present disclosure;

FIG. 3 is an antenna radiation/system efficiency chart illustrating VSWR tuning opportunities in accordance with the present disclosure;

FIG. 4 is a block diagram of a communication device with an antenna arrangement with a high band antenna on a top portion and a low band antenna on a bottom portion of the communication device in accordance with the present disclosure;

FIG. 5 is a flow chart illustrating a method of implementing a portion of the antenna arrangement in accordance with an embodiment of the present disclosure;

FIG. 6 is a graph illustrating antenna performance optimized for a portion of the PCS band in accordance with the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION

One embodiment of the present disclosure can entail a method of customizing an antenna including determining frequencies most likely used by a user of a communication device, selecting an antenna arrangement or assembly providing an optimized performance for the frequencies most likely used, and implementing the antenna arrangement or assembly onto a housing such as an extruded housing. For example, the antenna arrangement can be implemented by etching or applying customized metallization on the housing or by embedding metal within the housing.

Another embodiment of the present disclosure can entail a customized antenna arrangement for a communication device having a housing having etched thereon customized (or embedded therein) metallization providing optimized performance for frequencies most used based on at least one among usage information on a user's existing communication device and geographic locations where a user is most frequently found that correlates with subsets of a band corresponding to a carrier's coverage map.

Yet another embodiment of the present disclosure can entail a communication device comprising a customized antenna arrangement for a communication device formed on a housing portion having etched thereon (or embedded therein) customized metallization providing optimized performance for frequencies most often used by a user and a second housing portion for mating with the housing portion where the extruded housing portion and the second housing portion contain at least a transceiver coupled to a controller. In yet another embodiment, an existing communication device can be configured to collect frequency usage information (at either the communication device itself or remotely at a server for example) for later retrieval to use in configuring an antenna. A manufacturer or vendor can design or provide an antenna configured on a housing optimized accordingly to previously collected historical frequency information for use with the a new communication device or optionally as a replacement housing portion for the existing communication device.

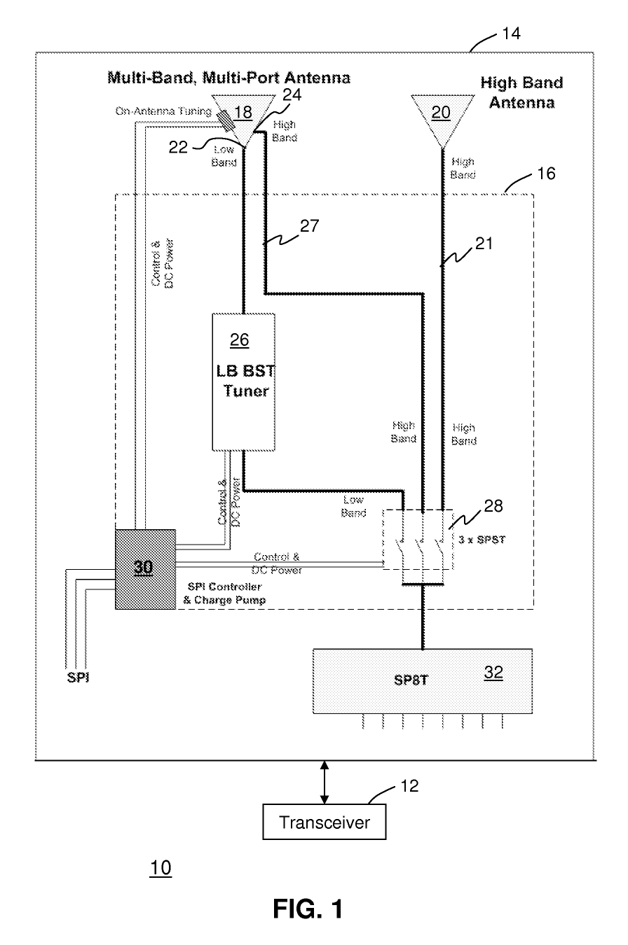

FIG. 1 depicts an exemplary embodiment of a multimode, multiband communication device 10 having a transceiver 12 and an antenna arrangement 14 or 16. Portions of the antenna arrangement 14 or 16 can be etched or embedded on to a housing or housing potion. The communication device 10 can include for example a multi-band or dual band antenna 18 that can reside at a bottom portion of the communication device 10 coupled to a communication circuit embodied as a transceiver 12, a low band tuner 26, a controller 30, and a switching mechanism 28. The antenna 18 (and/or any conductive runners coupled thereto such as conductor 27)) can be etched on or embedded within a housing.

The switching mechanism 28 can be coupled to a front end switch 32 (such as a single pole, eight throw (SP8T) switch) of transceiver 12. The antenna arrangement 14 can be operable to radiate or receive signals in lower bands under 1000 MHz such as the in the 850 and 900 MHz band ranges and can also be designed to optionally operate (in one embodiment, receive only) in higher band ranges over 1500 MHz such as in the 1800 to 2100 MHz ranges. The antenna 18 can be coupled to a diversity receiver (not shown, but may be part of transceiver 12). The antenna 18 can include a low band port 22 coupled to a signal line from the low band tuner 26 and a high band port 24 selectively coupled to a signal line 27 via the switch mechanism 28.

The communication device 10 can also include a multi-band antenna 20 that can reside at a top portion of the communication device 10 coupled to a communication circuit (such as multi-band transceiver 12 and switching mechanism 28), where the antenna 20 can be designed to radiate or receive signals in higher bands exceeding 1500 MHz and more likely ranging from 1700 to 2100 MHz. Thus, as used herein, “low band” refers to frequencies below 1000 MHz and “high band” refers to frequencies above 1500 MHz. An antenna can be optimized to operate at one or more frequencies or bands where signals are communicated with a minimum signal strength (typically in dBs) as may be set in a specification. The antenna 20 can be selectively coupled to transceiver 12 via a high band signal line 21 and the switching mechanism 28. In one particular embodiment, the controller 30 can be a Serial Peripheral Interface (SPI) controller having a charge pump coupled to a SPI interface, the tuner 26 can be a low band tuner using ferroelectric materials such as barium strontium titanate (BST) variable capacitors, and the switching mechanism 28 can be a triple single pole, single throw switch. Another switch 32 of the transceiver 12 can be a single pole octal throw switch. Note that the antenna 20 and/or the high band signal line 21 can also be etched on or embedded within a housing. Each of the antennas 18 and 24 can be customized for use for a particular user or carrier based on the frequencies most frequently used by the user and/or based on carrier's coverage map that includes particular assigned or licensed frequencies.

The transceiver 12 utilizes technology for exchanging radio signals with a radio tower or base station of a wireless communication system according to common modulation and demodulation techniques. Such techniques can include, but are not limited to, GSM, TDMA, CDMA, WiMAX, WLAN among others. The controller 30 utilizes computing technology such as a microprocessor and/or a digital signal processor with associated storage technology (such as RAM, ROM, DRAM, or Flash) for processing signals exchanged with the transceiver 12 and for controlling general operations of the communication device 10. The communication device 10 can separately include additional antennas at different locations such as a side antenna that can be a receive antenna in the range of 2100 MHz. Alternatively or optionally, the communication device can include a WLAN or Bluetooth antenna in operational range of 2440 MHz for example. The communication device 10 can also include a GPS antenna that operates in the range of 1575 MHz.

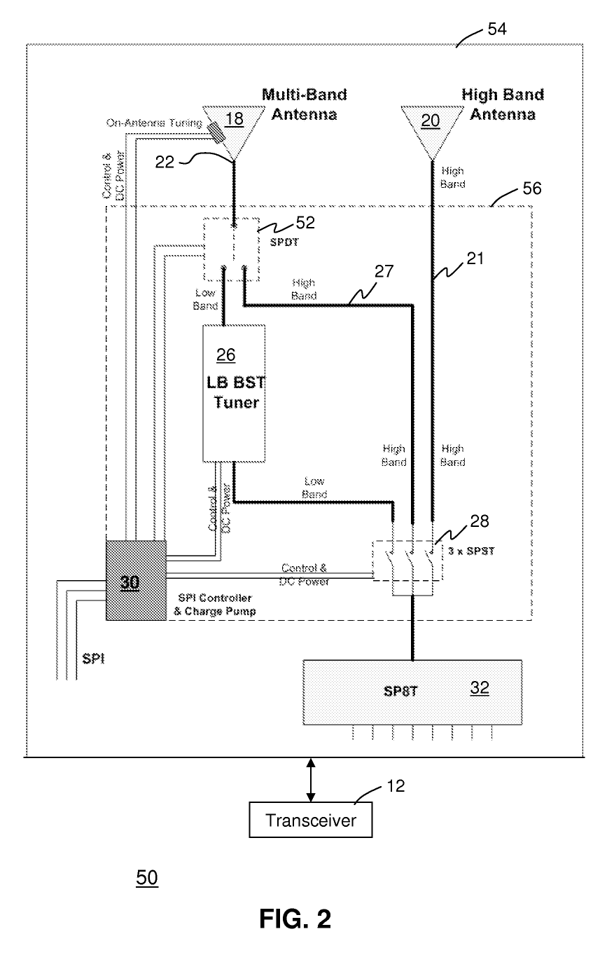

Referring to FIG. 2, a communication device 50 quite similar to the communication device 10 of FIG. 1 is shown. The communication device 50 primarily differs from the communication device 10 in that the communication device includes an antenna arrangement 54 or 56 that further includes a switch 52 as part of the switching mechanism to enable a selective connection to the multi-band antenna 18 from either the low band tuner 26 or the high band signal line 27. The switch 52 can be a single pole double throw switch as shown.

Again, the embodiments can determine apriori which pieces or portions of the spectrum a user is likely to use based on their geographic location and wireless carrier and then modify the antenna(s) to optimize operation of the antenna for the predetermined portions or pieces of the spectrum likely to be used.

With respect to peripheral aspect, some embodiments here hinge on an observation that the cause of loss of efficiency of an antenna due to a user can be attributed to predominantly impedance mismatch or resistive losses in user tissue and further recognizing that the lower bands' effects are typically include a significant contribution from impedance mismatch and the higher band effects are primarily due to resistive losses in the tissue.

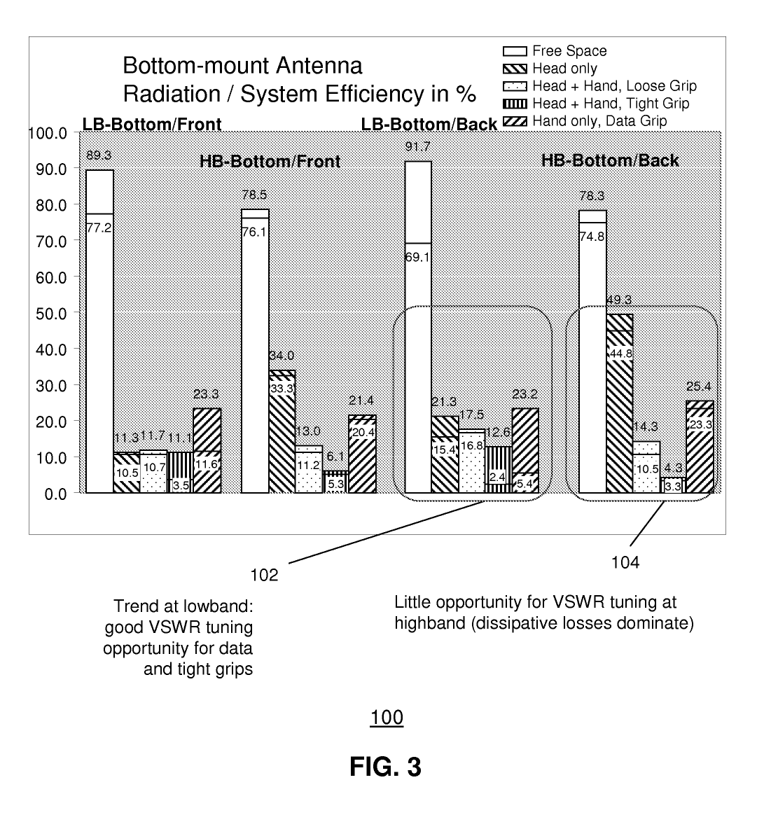

In combating hand effects, it is important to consider the two main mechanisms for loss of realized efficiency, absorption and mismatch, and the way in which these effects vary with frequency. The bar charts 100 of FIG. 3 illustrates what has been found to be a general trend for many types of antennas used on mobile devices. Two families of bar charts are shown, one for the low band and one for the high band. Within each family of bars, each bar represents one of five different use modes (like talk mode with loose grip, data mode with hand only, etc.). Each bar has two lines, the top one showing radiation efficiency, and the lower one showing system (realized) efficiency. (System or realized efficiency includes the negative effects of mismatch loss, whereas radiation efficiency includes only the effect of dissipative losses, assuming the antennas were perfectly matched.) From the low band family of curves, it can be seen that substantial degradation of system efficiency (e.g., the data mode use case) is due simply to mismatch loss (as evidenced by a large delta between radiation and system efficiencies). Hence, at the low bands, there is substantial opportunity for performance improvement just by implementing an adaptive voltage standing wave ratio or VSWR tuner on a single antenna as seen in section 102 of the bar graph. On the other hand, from inspection of the high band family of curves as seen in section 104 of the bar graph, it is seen that there is little opportunity for improvement from a VSWR tuner (radiation and system efficiencies are nearly the same).

Although most embodiments disclosed herein involve a dual band or multi-band antenna that covers both high and low bands and a separate high band antenna, Applicants contemplate within the scope of the claimed embodiments that 2 (or more) separate multi-band antennas can be implemented to provide low band and high band diversity or MIMO (Multiple Input, Multiple Output) if necessary. Note that two separate multi-band antennas that both cover low bands may require a larger volume configuration than an arrangement that has separate multi-band antennas where at least one of the antennas only covers high bands. Applicant also contemplate that a single customized antenna etched or embedded within a housing can also be within the scope of the claimed embodiments.

Although antenna systems are primarily designed for voice-centric devices, the more current devices shipping or being developed are not necessarily voice-centric. The market already demands devices that are optimized for SMS usage, for example QWERTY-optimized landscape-mode devices, and it can be anticipated that high-data-rate applications will also come to play a significant part in the user experience. Hence, in addition to supporting good radiated performance in the talking mode (device held to head at the ear), new designs should have high RF functionality when held in one or more data modes of operation (device held in one or both hands while viewing the display).

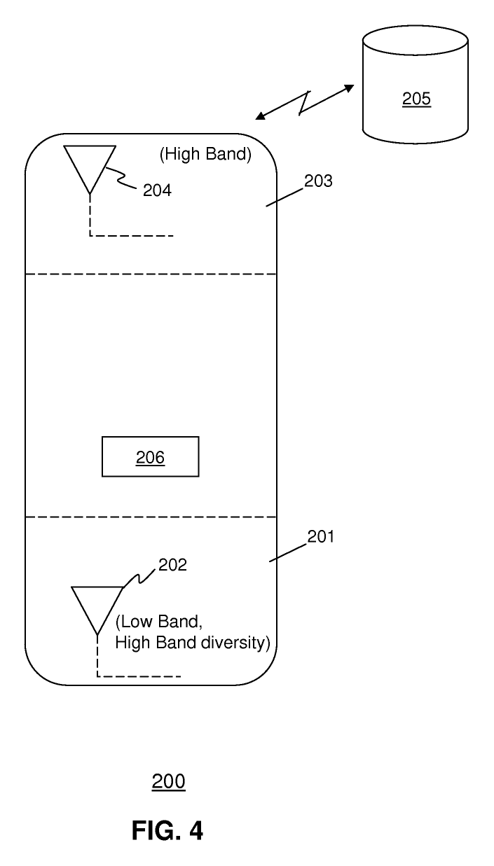

Current antenna architectures or platforms with the antenna located at the bottom of the phone are highly optimized for talk mode and rather disadvantaged for many data modes of operation. Embodiments herein provide an antenna architecture or arrangement that can support the necessary multiple, conflicting, use modes in a single device, while minimizing any volume, cost, and complexity added to the antenna system. Such an antenna system as shown in the communication device 200 of FIG. 4 can include an antenna 202 in a lower housing portion 201 of the communication device 200 and operable primarily in the low band ranges and optionally in the high band ranges for diversity while a top housing portion 203 of the communication device 200 can carry a separate antenna 204 for high band operation. Note that either antenna 202 or 204 can be etched or embedded in a customized fashion within the housing for particular frequency bands as indicted by customer usage or carrier licenses for particular coverage areas frequented by the user. The communication device 200 can include a memory 206 and the device 200 can be in communication with remote storage devices such as server 205. As contemplated within the scope of the embodiments, the antennas 202 and 204 are not limited to being etched or embedded into a particular housing portion as discussed above, but the particular arrangements noted above do assist in avoiding hand affects as further discussed below.

The positioning of the antenna can be arranged to be optimized for hand effects. Antennas located at the top of the phone or communication device tend to have less efficiency degradation due to a hand grip. For a given hand grip, the efficiency degradation is more severe in the higher frequency bands. Therefore the antenna serving the higher frequency band can be located at the top of the phone. The positioning of the antennas can also be arranged to adjust Specific Absorption Rates or SAR. Antennas located at the bottom of a phone may have lower SAR. If the transmitter power is highest in one band, then the antenna serving the “higher power” band can be located at the bottom of the phone, so that SAR can be reduced to help meet government SAR regulatory requirements. Typically the transmitter power is highest in a low band. Therefore the antenna serving the lower frequency bands can be located at the bottom of the phone.

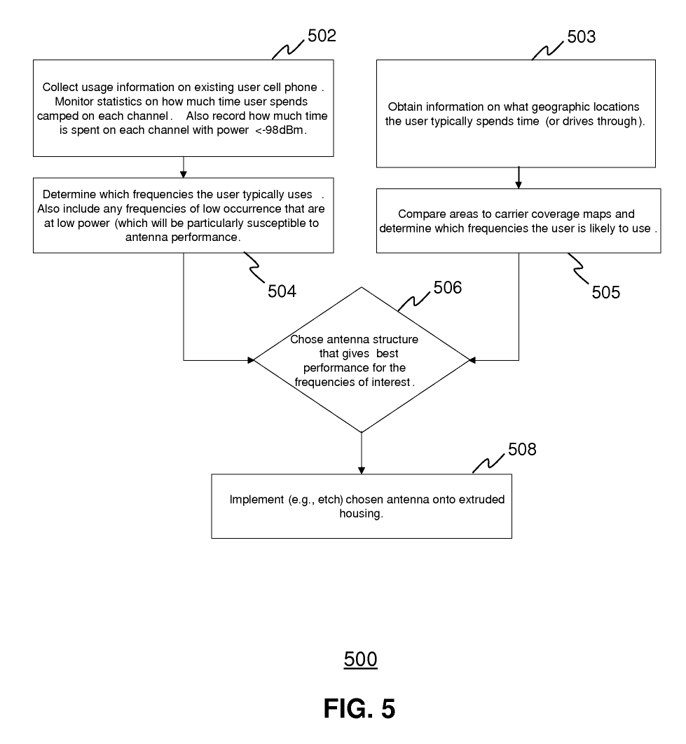

A manufacturer or user can select or implement an antenna or antenna arrangement that will be most optimal to a user's patterns of use. The selected antenna can be etched on or embedded into an extruded housing or otherwise implemented to allow the phone to be customized to enhance performance at the frequencies of most interest to a specific customer (or operator). This selection of optimized base antenna structure can preferably be done at the point of sale of the phone. In one embodiment 500 as shown in the flow chart of FIG. 5, usage information on an existing user's cell phone can be collected at 502. For example, statistics on how much time a user spends camped on each channel can be monitored. In one embodiment, the amount of time spent on each channel with a power or channel quality less than a predetermined threshold can be monitored. The threshold can also be programmable and set within a range of values. The threshold is selected to provide data in those situations when the received signal strength is below average or marginal, and for typical cellular systems can for example be a value less than approximately −80 dBm, and in one embodiment it is envisioned that the threshold can advantageously be −98 dBm to limit the amount of data collected (and thus limiting storage memory size requirements). This threshold level can be higher for systems with higher sensitivity thresholds, and lower for systems with lower sensitivity thresholds. Whenever the channel power [or a channel quality] drops below a desired threshold, the occurrences can be counted or recorded, or more particularly the actual time spent below the threshold can be recorded with respect to the frequency. At 504, the frequencies which the user typically uses can be determined, and the frequencies of that are at low power which are particularly susceptible to poor antenna performance can also be determined. The communication device may include a memory element (as noted above with respect to memory 206 of FIG. 4), such as a flash ROM, for recording the historical frequency information, or a removable memory card, or the like. It is alternatively envisioned that the information, or data, relating to historical frequency use can be stored at a network server (such as server 205 of FIG. 4) and associated with the user, whereby the user's historical, or past, frequency use can be retrieved when the user orders a communication device or orders a replacement housing for an existing communication device. The customized communication device could then be manufactured with the optimum antenna arrangement and shipped to the user or an authorized local vendor. The user's current communication device can thus contain an antenna optimized for previous historical frequency use and collect new frequency use data for the next time the user's antenna is updated, either through purchasing a new communication device or updating the current communication device with a new housing shell or antenna.

Alternatively or optionally, the embodiment 500 can determine the typical geographic areas or locations that the customer will use the phone based on data from previous phone use (using known location determining techniques such as GPS, triangulation, time of arrival, cellular tower identifiers, and the like) or inquiring of the user which locations the customer expects to use the phone, as indicated at 503. Based on the usage patterns, a carrier can compare with carrier coverage maps or otherwise determine which frequencies are mostly likely to be used, at 505. At decision block 506, an antenna structure, or arrangement, can be chosen that provides the best performance for the frequencies of interest. At 508, the optimal antenna chosen can be implemented for example by etching the antenna into an antenna blank, such as a metal sheet or a metal surface of a housing or circuit board, or the housing itself where the housing is constructed to include the antenna, such as in an extruded conductive housing. Of course, implementation could also optionally involve predetermined switch settings or tuning as contemplated herein.

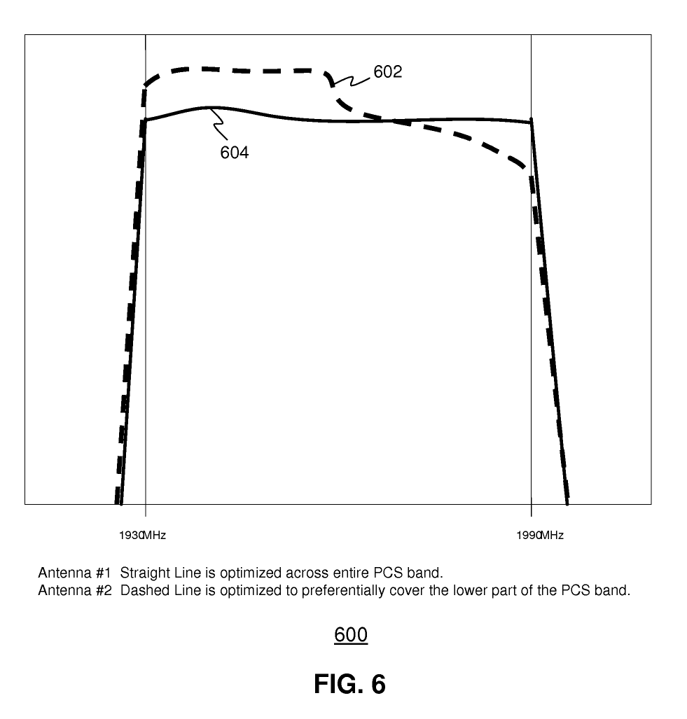

Antennas today are optimized to cover multiple bands, and attempt to cover all the bands equally as illustrated by the straight line 604 of the graph 600 of FIG. 6. Instead, it can be useful to optimize the antenna to preferentially cover portions of the bands the user is most likely going to use. For example, the dashed line 602 is optimized to preferentially cover the lower portion of the PCS band closer to the 1930 MHz range. Carriers (or operators) own a small subset of any band in a given region. (For example, the PCS band is divided into 6 sub bands A,B,C,D,E and F). Generally, antennas have been optimized to cover the entire frequency band, but for customers that use their phones predominantly in a specific location, optimizing the antenna for the frequency channels the customer will use will provide an improved experience in call performance and data throughput. Note that this apriori optimization can be combined with active tuning techniques such as closed-loop active tuning which can optimize on a per-channel basis within the capability of a given antenna configuration (banding). This can also be combined with diversity switching techniques as well.

As noted with respect to FIG. 1, the communication devices or arrangements can further include a Bluetooth or WLAN antenna as well as a GPS antenna if desired. The first antenna 18 and the second antenna 20 can reside on a keypad board of the wireless communication device 10 or 50. Note that the first antenna and the second antenna are separately located to provide spatial diversity in addition to the split band or frequency diversity. The wireless communication device can operate to switch phone operation between bands associated with the separately located antennas based on hand grip loading imposed on the antennas. Thus, the arrangements disclosed can also provide better call drop performance.

The configurations described herein can provide for a single element antenna covering a single band (having certain portions or subsets of the bands optimized) or for a multi-element multi-band internal antenna arrangement that can cover multiple GSM or UMTS bands (850 MHz, 900 MHz, 1700 MHz, 1800 MHz, 1900 MHz for example) and optionally both domestic and International WiMAX bands (2.5 GHz and 3.5 GHz). The arrangement can also cover the 2100 MHz band. Thus, the antenna configurations described can serve as a quad-band GSM dual band WiMax antenna or a Pentaband dual Band WiMax (or BlueTooth) antenna that can also separately include a GPS antenna for reception of GPS signals.

As described above, the antenna arrangement(s) can be made directly in the housing. For example where the housing is either constructed of extruded or sheet metal, or metalcan be insert molded using a multi-shot method. It is envisioned that at least a portion of the antenna arrangement can be customized by etching or other customization using the housing of such a communication device. The antenna arrangement can comprise any combination of loop antennas, folded dipoles, transmission lines, PIFA like elements, L-type stubs or other arrangements that provide the desired band operations and the requisite diversity and performance under various hand grip scenarios.

The specification and figures are to be regarded in an illustrative rather than a restrictive sense, and all such modifications are intended to be included within the scope of present invention. For example, the embodiments claiming methods can involve computer programs that operate machines that etch or embed metal or metallization onto or into a housing used for communication products. The benefits, advantages, solutions to problems, and any element(s) that may cause any benefit, advantage, or solution to occur or become more pronounced are not to be construed as a critical, required, or essential features or elements of any or all the claims. The embodiments herein are defined solely by the appended claims including any amendments made during the pendency of this application and all equivalents of those claims as issued.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method of customizing an antenna for a particular communication device for an associated user, comprising:
determining frequencies most likely to be used by the communication device associated with the user from historical frequency use information;
selecting an antenna assembly tuned for the frequencies most likely to be used by the particular communication device; and
implementing the antenna assembly in a housing of the particular communication device.

2. The method of claim 1, wherein determining frequencies is done by collecting usage information associated with a user's communication device.

3. The method of claim 1, wherein determining frequencies is done by monitoring statistics on user time spent camped on each channel.

4. The method of claim 3, wherein the method records how much time is spent on each channel with power less than a predetermined signal strength.

5. The method of claim 1, wherein the method determines frequencies of low occurrence that are at low power.

6. The method of claim 1, wherein determining frequencies is done by determining which geographic location the user typically spends time in.

7. The method of claim 6, wherein the method compares geographic locations with carrier coverage maps.

8. The method of claim 1, wherein the implementing is done by etching the antenna arrangement from an antenna blank.

9. The method of claim 1, wherein the method further uses adaptive tuning.

10. A customized antenna arrangement for a communication device, comprising:
an extruded housing having etched thereon customized metallization providing optimized performance for frequencies most used based on at least one among usage information on a user's existing communication device and geographic locations where a user is most frequently found that correlates with subsets of a band corresponding to a carrier's coverage map.

11. The customized antenna arrangement of claim 10, wherein the frequencies most used is determined by monitoring statistics on user time spent camped on each channel.

12. The customized antenna arrangement of claim 11, wherein a metallization pattern is determined on how much time is spent on each channel with power less than a predetermined signal strength.

13. The customized antenna arrangement of claim 10, wherein the arrangement comprises an adaptive tuner coupled to the customized antenna arrangement and wherein the customized antenna arrangement is for a multimode communication device.

14. The customized antenna arrangement of claim 10, wherein the metallization is on a replaceable extruded housing, wherein replacement housings can be customized for different geographic areas of use based on carrier frequency assignments, licenses, and frequency use history.

15. A communication device, comprising:
a transceiver;
a customized antenna arrangement for the communication device formed on a first housing portion having etched thereon customized metallization providing optimized performance for frequencies most often used by a user; and
a second housing portion for mating with the first housing portion, wherein the first housing portion and the second housing portion enclose at least a substantial portion of the transceiver coupled to a controller.

16. The communication device of claim 15, wherein the customized metallization pattern is determined on how much time is spent on each channel with power less than a predetermined signal strength.

17. The communication device of claim 15, wherein the communication device is a multimode communication device and further comprises a tuner coupled to the controller and customized antenna arrangement.

18. The communication device of claim 15, wherein the customized metallization is on a replaceable extruded housing, wherein replacement housings can be customized for different geographic areas of use having different frequency assignments.

19. The communication device of claim 15, wherein the communication device comprises a Voltage Standing Wave Ratio (VSWR) tuner coupled to the controller and wherein the controller operates to monitor reverse power on the customized antenna arrangement and adjusts matching elements to modify return loss to lower reflected power.

20. The communication device of claim 19, wherein antenna arrangement includes a switching mechanism for selecting between the first antenna formed by the customized metallization and a second antenna, wherein the controller operates to monitor the predetermined use modes of the multimode communication device among voice mode using an earspeaker, data mode of operation in a user's hand, received signal quality in a diversity system and wherein the mode of use determines the operation of the switching mechanism.

21. The communication device of claim 15, wherein the controller operates to collect frequency usage information for subsequent retrieval for use in configuring a customized antenna when a user orders among a new communication device and a replacement housing for the communication device.

22. A communication device, comprising:
a housing;
a transceiver carried in the housing;
a controller coupled to the transceiver, wherein the controller operates to collect frequency usage information for subsequent retrieval and use in configuring a next custom antenna; and
a current custom antenna carried in the housing and coupled to the transceiver, the custom antenna having metallization configured for optimum performance at frequencies associated previously collected frequency usage information.

23. The communication device of claim 22, wherein the controller operates to collect frequency usage information at one of a memory within the communication device and a memory at a location remote from the communication device.

24. A communication device, comprising:
a transceiver;
a controller coupled to the transceiver, wherein the controller collects frequency usage information for subsequent retrieval to use in configuring an antenna, the controller collecting the amount of time that the transceiver operates at each frequency with a receive signal strength below a threshold.
